(19) United States
(12) Patent Application Publication
(10) Pub. No.: US 2006/0031239 A1
(43) Pub. Date: Feb. 9, 2006

(54) Methods and apparatus for authenticating names

(76) Inventor: Daniel William Koenig, Placentia, CA (US)

Correspondence Address: STEPHEN M. NIPPER;DYKAS, SHAVER & NIPPER, LLP, PO BOX 877, BOISE, ID, 83701-0877, US

(21) Appl. No.: 11/240,915

(22) Filed: Sep. 30, 2005

Related U.S. Application Data
(63) Continuation-in-part of application No. 11/180,306, filed on Jul. 11, 2005.
(60) Provisional application No. 60/587,300, filed on Jul. 12, 2004.

(51) Int. Cl. G06F 7/00

(52) U.S. Cl. 707/100

(57) ABSTRACT

Systems and methods for developing, managing and utilizing a name database including a plurality of records each associated with a name with one or more variants and/or equivalents. The name database is driven by geographic, cultural, and linguistic considerations. The name database provides searchers across multiple disciplines, industries, and governments the ability to determine quickly and accurately all possible variants of a name from a query of the database.

### CROSS-REFERENCE TO RELATED APPLICATION

The present application claims priority under 35 U.S.C. 19(e) on U.S. Provisional Application for Patent Ser. No. 60/587,300, filed Jul. 12, 2004, the entire disclosure of which is incorporated herein by reference, and is a continuation in part of application Ser. No. 11/180,306, filed on Jul. 11, 2005 by Daniel William Koenig, et al., the entire disclosure of which is incorporated herein by reference.

### FIELD OF THE INVENTION

The invention relates to methods and apparatus for the collection, sorting, filtering, organizing, assigning, indexing, searching, and retrieval of personal and family names and related variant, colloquial and equivalent name forms by utilizing linguistically and culturally based non-algorithmic comparison and verification techniques.

### BACKGROUND OF THE INVENTION

For many years there has been an unfulfilled need to address the basic issues of accurately identifying an individual's name and/or aliases, along with their language, cultural background and country of origin. Name forms change ever more quickly, driven by the combined forces of immigration and cultural assimilation—soon enough, through no fault of his own, Vasilios is known as Bill, and the first break in the chain of identity has occurred.

For the most part this is due to the complexities of human language itself and the various forms and meanings it takes on. With over 41,000 documented dialects and alternate language names affecting over 6,800 current spoken languages in over three hundred countries, the task of organizing and maintaining these diverse data sets, not to mention the interpretation thereof, is time and cost prohibitive.

The data elements required to create these solutions are often readily available but not always accessible in a user-friendly or logical format. The promise of improved technologies and leading edge computing power has done little to improve on the problem. Many search algorithms still return results with “Joan” mixed together with “John”, and algorithms such as Soundex cannot always be relied upon to produce accurate results. [Soundex is an algorithm for encoding a word so that similar sounding words encode the same, in which the first letter is copied unchanged then subsequent letters are encoded as numbers; other characters are ignored and repeated characters are encoded as though they are a single character.] These tools can be fine tuned incrementally and adjusted to improve the hit ratio [i.e., the ratio of the number of times data requested from a cache is found (or hit) to the number of times it is not found (or missed)], but the fact remains that they continue to provide a less than perfect level of accuracy.

### BRIEF SUMMARY OF THE INVENTION

According to one aspect of the invention, a precision name authenticator provides a name search software solution designed as an “add-on” search tool enhancement to Internet, enterprise, and other search engines, business applications, OFAC financial compliance requirements, law enforcement, public record retrieval, governmental requirements, and medical research. The name authenticator increases the accuracy of name matching by determining all available alternate name forms, which is referred to herein as variants for the subject query. A variant is an alternate name form derived primarily through changes which are orthographic (e.g., spelling) and/or phonological (i.e., sound). Variants take on a number of primary forms, including root, stem, and branch. The variants may be based on any number of characteristics of a name, including gender, language, culture, country, region, and so on.

In addition to linguistic-specific variants and colloquial forms, variants also include equivalent name forms for other countries and languages, along with variants derived from foreign name assimilations (SYMvar) and name forms comprised of logical equivalents from regions with a common linguistic and/or cultural heritage (REGvar). Additional search tools such as anagrams, forbidden name forms, honorifics, highest probability names for initials, and highest probability names for matched or unmatched personal and family names (SURvar) provide the user with both a simplistic search path and a means of expanding the name search onto a fully dynamic worldwide scale.

In a number of embodiments, the methodology of the invention (which is referred to by the inventors as Personae™) offers full text searching of personal and family names for over one hundred languages and cultural groups, covering multiple geographic regions and countries on a worldwide basis. Industries, entities, and applications that may utilize any number of embodiments of the invention may include, but are not limited to:
Name Search Engines—increased accuracy for Google, Dow Jones, e-commerce “glocalization”, and so on
Public Records Searches—exposing bankruptcies, tax liens & civil judgments.
Locating Assets & Liabilities—required due diligence in business transactions
Real Estate Industry—chain of title searches, mortgage & escrow services, foreign national identity search.
Background Screening—pre-employment, security clearances, sex offenders.
News Gathering Services—news media, factual data, news clipping searches.
Medical Research—health statistics & medical studies by gender, ethnic group.
Financial Institutions—stocks, investments and new banking law requirements.
Police Investigations—computer crimes, white collar fraud, hate crimes, ID theft.
Fraud/Risk Analysis—insurance claims, government programs, welfare fraud.
Government Support—DMV, entitlements, USPS, imnnigration-visa/passport.
Application Software—spell check, name verification, court reporting software.
Genealogical Research—tracing family trees, name form predictive tools.
Terrorism Threats—Homeland Security, FBI, Border Patrol, local government.
Mass Mailing and Fulfillment—cleanse records and prevent redundancy.
Data Cleansing—purge records that differ only by variant name form.

Other features and advantages of the present invention will become apparent to those skilled in the art from a consideration of the following detailed description taken in conjunction with the accompanying drawings.

### BRIEF DESCRIPTION OF THE DRAWINGS

FIG. 1 illustrates a system for implementing methodology for generating, maintaining, and utilizing a name database.

FIG. 2 illustrates an example of a name database according to some of the embodiments.

FIG. 3 illustrates a number of embodiments of methodology for generating a name database.

FIG. 4 shows a definition of rules utilized by the methodology.

FIG. 5 shows a definition of codes utilized by the methodology.

FIG. 6 illustrates a number of embodiments of methodology for maintaining a name database.

FIG. 7 illustrates a number of embodiments of methodology for enabling e-commerce with name variants.

FIG. 8 illustrates a processing level for generating a name database according to a number of embodiments.

FIG. 9 illustrates an example of codes associated with a name in a database.

FIG. 10 illustrates principles associated with lingual codes relating to language/culture name form designations.

FIG. 11 illustrates principles associated with geos codes relating to language/culture name form designations.

FIG. 12 illustrates an example of a search screen.

FIG. 13 illustrates one embodiment of the present invention.

### DETAILED DESCRIPTION OF THE INVENTION

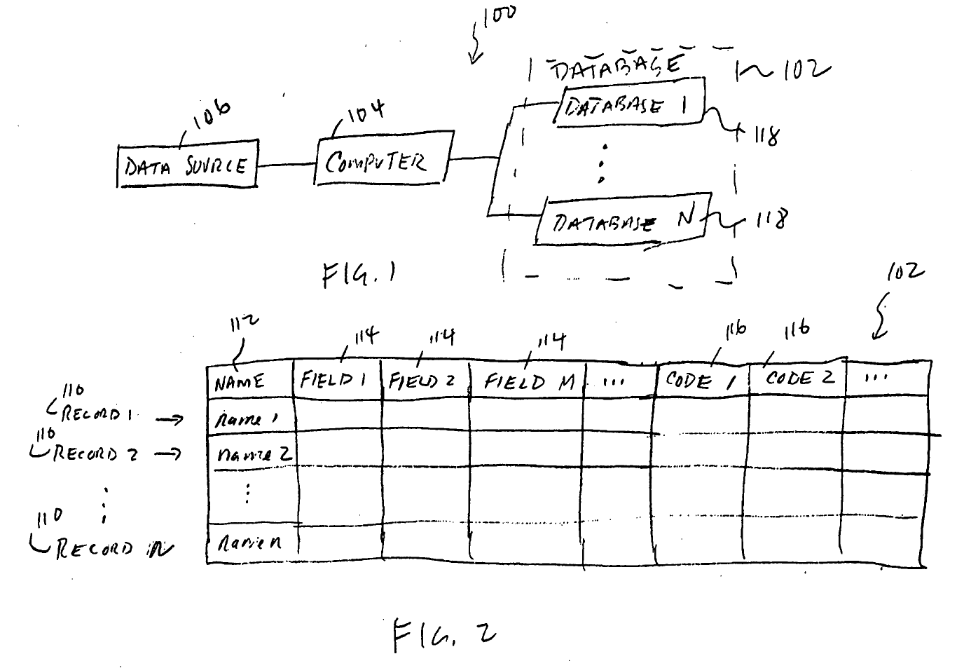

Turning to the drawings, in FIG. 1 a system 100 for generating and maintaining a name database 102 may include a computer 104 with, as known in the art, a processing circuit, memory, interfaces, and so on. The methodology of the invention may be implemented in the form of application software that is executable on the computer 104. Data associated with names from an external source 106 is receivable on the computer 104 for processing in accordance with the methodology described herein.

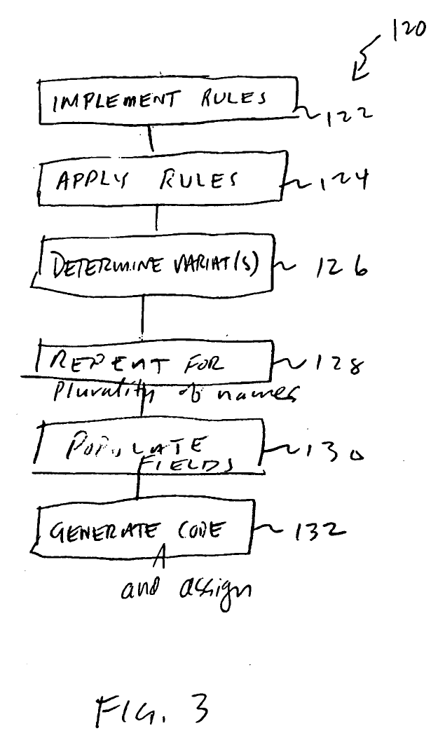

As shown in FIG. 2, the database 102 may include a plurality of records 110. Each of the records 110 is associated with a name 112 and each includes a plurality of fields 114. Each of the fields 114 is associated with a variant of the name 112. Each of the records may also include one or more codes 116 that are generated according to a plurality of rules of various embodiments of the invention. The codes 116 may be indicative of one or more characteristics of the name 112, which is described in more detail below.

For the purposes of this description, a name 112 may have a plurality of characteristics, at least one origin, and at least one but potentially a plurality of variants. More specifically, the characteristics of a name 112 including spelling, punctuation, special characters and cultural significance (“forbidden” Islamic name forms). The origin of a name 112 may be a country (e.g., England, China, the United States, etc.) and/or a language (e.g., English, Farsi, Spanish, Mandarin Chinese, etc.). Examples of variants of the name John include Jon, Jonathan, Johnny. Examples of equivalent names for John, with an equivalent name being a sub-class or category of variant, include Juan and Johannes. A name 112 may be, for example, a given name, a surname, or both. Also for the purposes of this description, there is a glossary of terms at the end of this description that defines a number of terms used herein.

As shown in FIG. 1, the name database 102 may include a plurality of specific databases 118, such as language-specific databases or country-specific databases. Alternatively, the specific databases 118 may be generated to be specific to a particular function or organization.

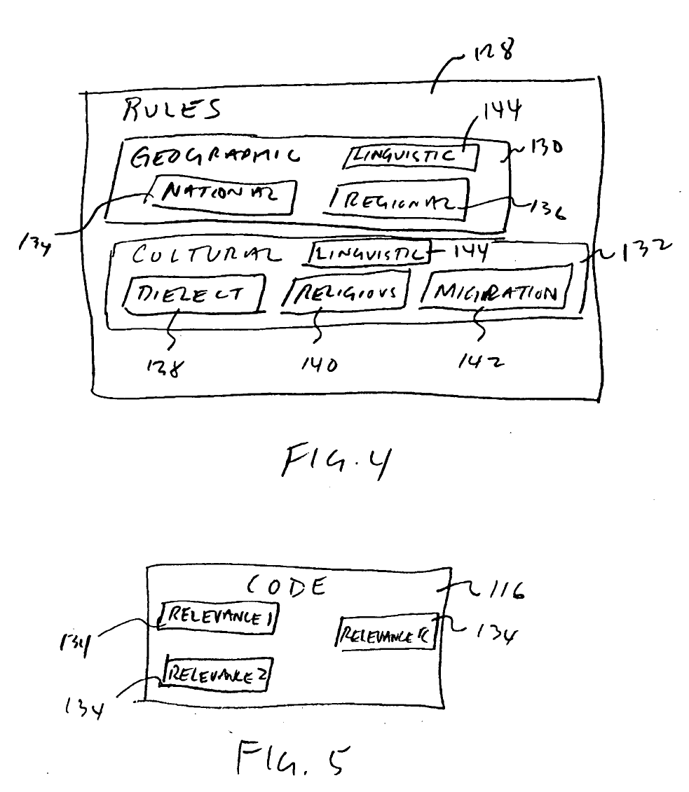

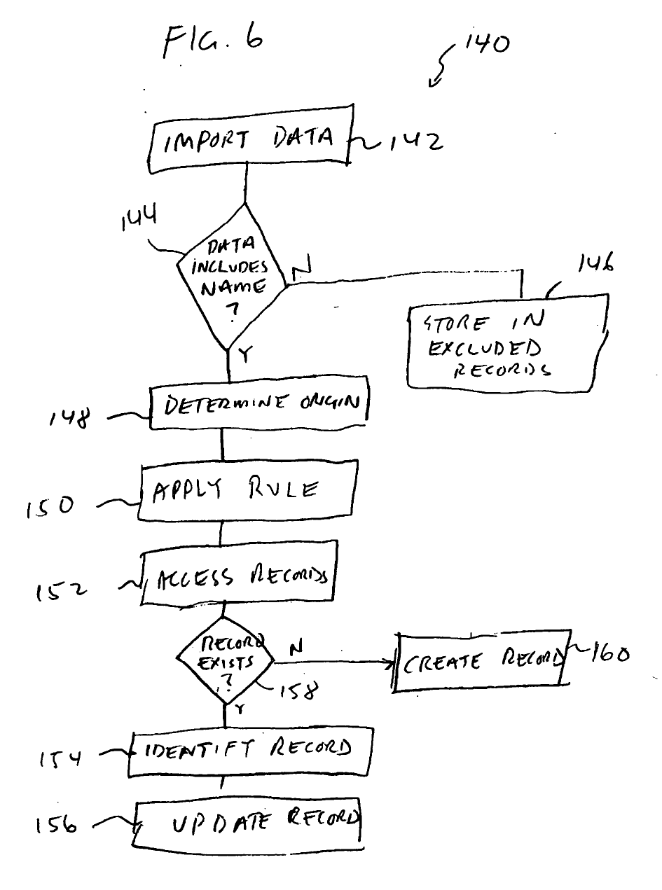

According to a number of embodiments, methodology 120 for generating the name database 102 is illustrated in FIG. 3 and may include implementing 122 a plurality of rules for analyzing the characteristics of the name and then applying 124 at least one of those rules to a name to determine the origin of the name. The plurality of rules 126 are configured to determine one or more variants of a name based upon the characteristics of the name. As shown in FIG. 4, at least a number of the rules 128 may be based upon at least one if not both of a set of geographical parameters 130 and cultural parameters 132.

The geographical parameters 130 may include national (i.e., country) parameters 134 and regional parameters 136. Examples of regional parameters 136 of a name may include Los Angeles, Southern California, the American Southwest, Spanish-influenced America, and so on. Cultural parameters 132 may include dialect parameters 138, religious parameters 140, and migration parameters 142. Examples of dialect parameters 138 in the English language include British English and American English. Examples of religious parameters 140 may include rules associated with Islamic law for Arabic names. Examples of migration parameters 142 include name assimilation of an immigrant community into a new country, such as Turkish immigrants in Germany. Linguistic parameters 144 may be a part of the geographic parameters 130 and the cultural parameters 132. Examples of linguistic parameters 144 include graphemes, phonemes, and morphemes as well as flagged special characters and/or diacritical marks outside the expected range which determine “loan” names outside the region, language and/or culture. If the “loan” name form exceeds a statistical threshold, it is assigned a “loan name” code such as fraDE (French loan name, Germany).

With continued reference to FIG. 3, in addition to determining whether the name 112 has an origin, the applying step 124 may also determine a language of the origin of the name 112 or a country of the origin of the name 112. It may then be determined 126 whether the name 112 has a variant. More specifically, if the name 112 has a variant, to determine one or more variants of the name 112. This process may be repeated 128 for a plurality of names. The fields 114 of each record 11 associated with the name 114 may then be populated with the determined variants of the name 112. A user may then query the database 110 to determine, for example, all of the variants of a particular name 112. Any number of queries may be made of the database 102. The rules applied in the method 120 may be continuously added to and modified based on current changes or norms in geographic and/or cultural use.

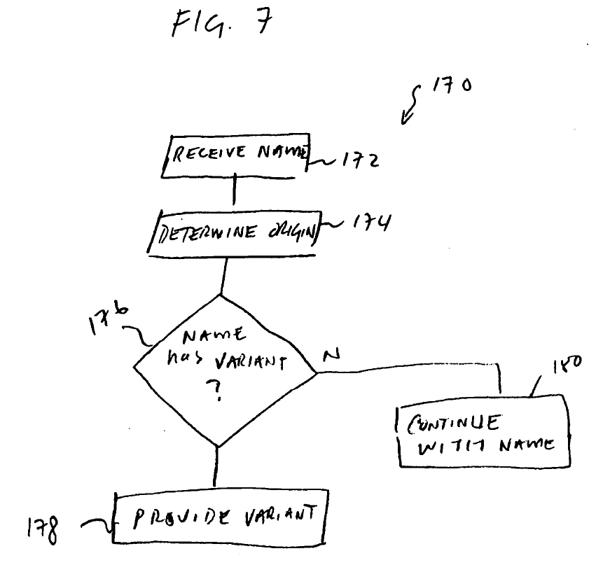

In addition to populating the fields 114 with variants, one or more codes 116 may be generated for and/or assigned to 132, each of the records 110 based on at least one of the rules 128. As shown in FIG. 5, the codes 116 may include a plurality of relevances 134. Each of the relevances 134 of a particular code 116 may be associated with a particular characteristic of the name 112, such as language, country, region, sub-region, and gender. The relevances 134 of another particular code 116 may be associated with characteristics of the name 112 based on activity in the database 102, such as authority (or non-authority), popularity, number of hits, and so on. One or more of the codes 116 may be identified uniquely with a single one of the names 112. By analyzing one of the codes 116, a number of characteristics and properties of the name 112 can be determined or ascertained.

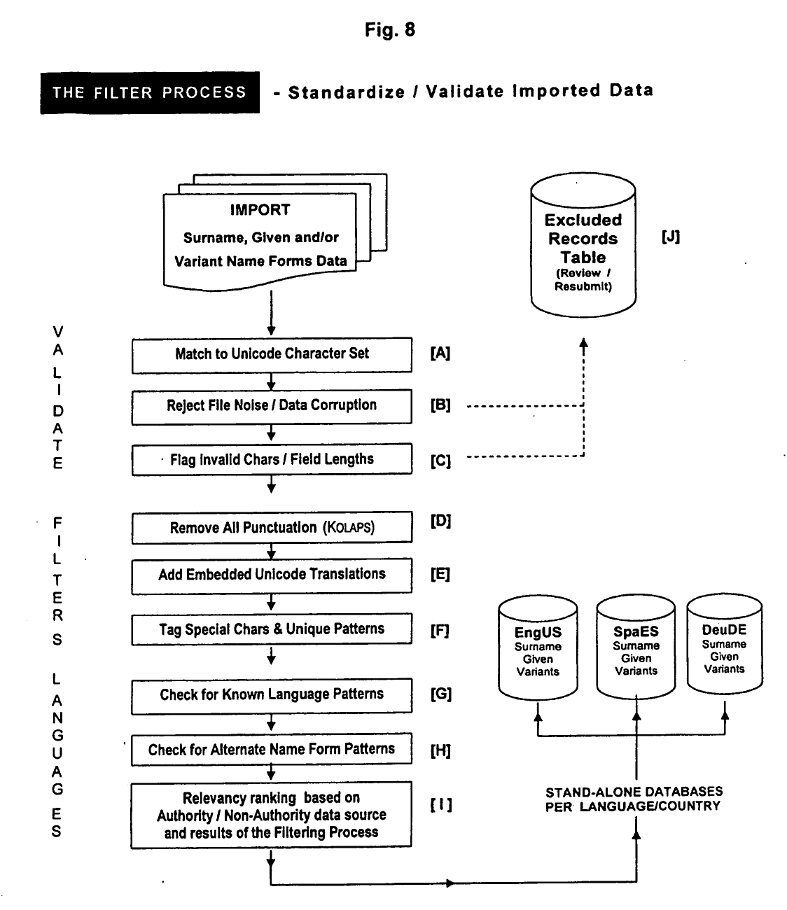

In still other embodiments of the invention such as shown in FIG. 6, a method 140 for maintaining a name database 102 such as that shown in FIG. 2. The method 140 may include importing data 142 from an external data source 106 (see FIG. 1), such as from the Internet, the media, government sources, historical sources, and so on. When imported, the computer 104 may then determine 144 whether the data includes a name 112. If not, then the data may be stored 146 in an excluded records table for future processing if desired. If the data does have a name 112, then the origin of the name 112 may be determined 148, and then one rule 128 may be applied 150 to the name 112 based on the origin to determine whether the name 112 has a variant.

If the name 112 has a variant, then the records 110 having the same origin as the origin determined from the name 112 (in step 148) may be accessed 152. These accessed records 110 may represent or be comprised into one of the sub-databases 118 as shown in FIG. 1, such as an English database 118, a Spanish database 118, and so on. From there, the record 110 associated with the name 112 of the imported data (from step 142) may be identified 154. From the identified record, a user may then determine any and all of the variants of the name 112 contained in the fields 114. A user may also analyze one or more of the codes 116 of the identified record 110, such as determining from the relevances 134 from the code 116 the number of times the record 110 has been identified. In addition, the relevance associated with the number of times the record 110 has been identified may be updated 156, e.g., increasing that particular relevance by 1.

If a record 110 could not be identified (in step 154), then it may be assumed that a record 110 does not exist 158 in the name database 102 for the name from the imported data. If this is the case, then a record 110 associated with the name from the imported data may be created 160.

In still other embodiments of the invention such as shown in FIG. 7, a method 170 enables e-commerce for a user on a computer with a top-level domain (Tld). In this method 170, when a user enters a name on a website, a server or computer receives 172 the name of the user and may then determine 174 the origin of the name. From there, it may then be determined 176 whether the name has any variants by, for example, applying at least one of the rules 128 to the name based on the origin. If the name has a variant, then the variant may be provided 178 to the user. If there is no variant, then the e-commerce transaction may proceed with the name of the user 180. The Tld of the user may be utilized in determining the variant of the name (step 176). For example, the records 110 may include a field associated with the Tld. When the user enters his or her name, the Tld may be determined and then used to access or identify the records 110 associated with the Tld. Once the Tld has been determined, the Tld is mapped to the database 102 to determine a geographic location of the user. Based on the geographic location (e.g., country) information coupled with the other cultural data in the database 102, an e-commerce provider or merchant can then provide to the user country-specific, location-specific, demographic-specific, cultural-specific, and/or lingual-specific information during the transaction, e.g., targeted marketing information.

To supplement the foregoing description, provided below is a more detailed description of various embodiments of the methods and apparatus of the invention.

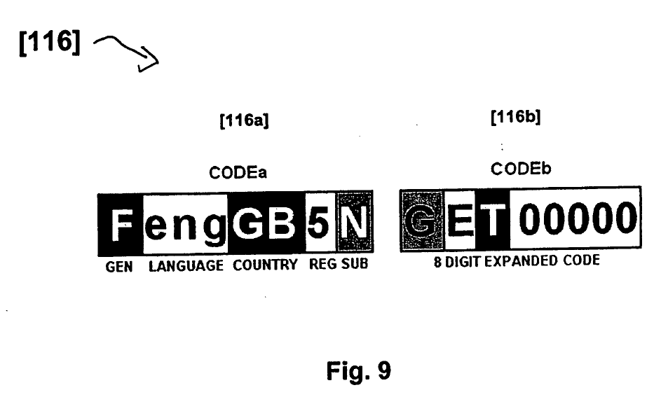

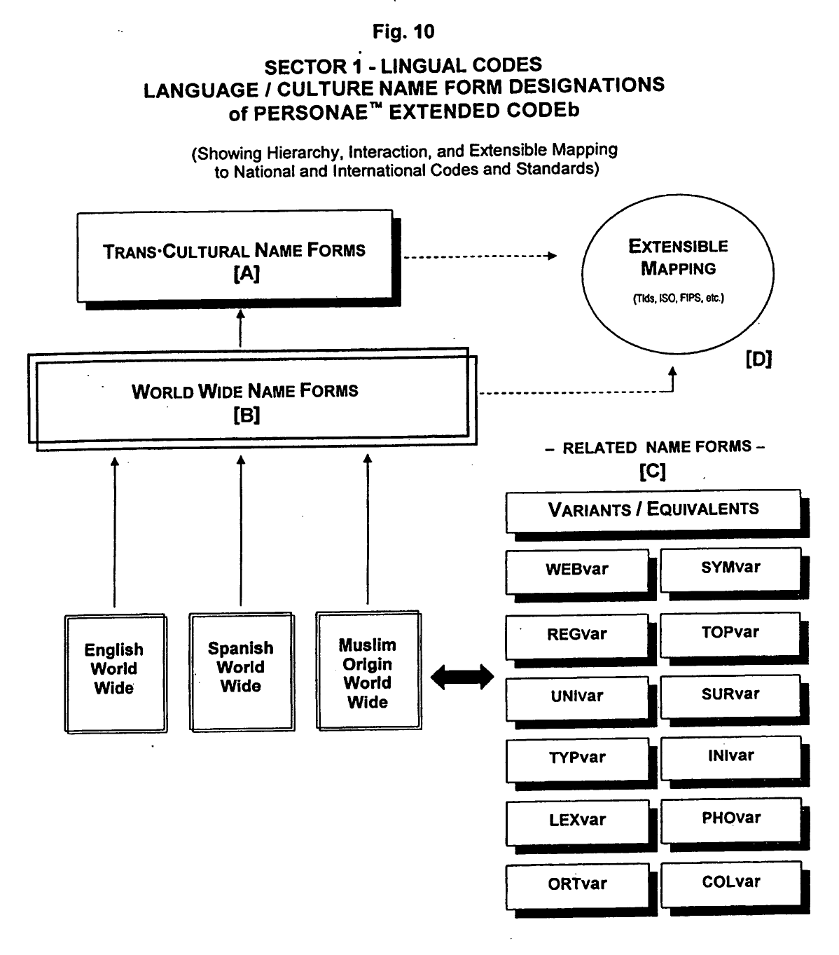

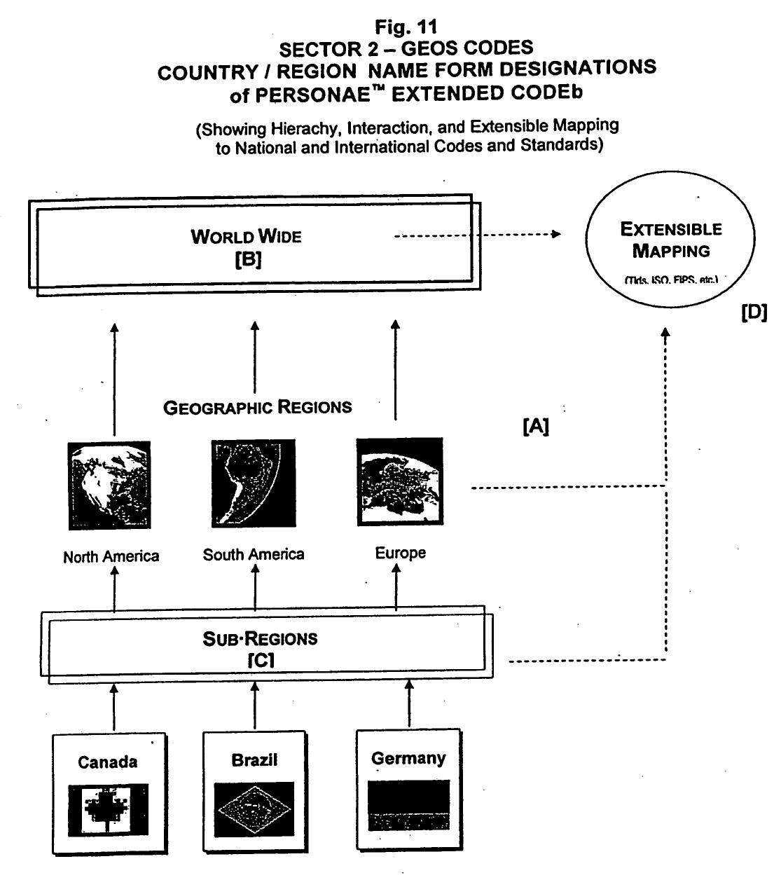

Processing Level 1. The following may be implemented according to a processing level 1 methodology illustrated in FIG. 8. A number of the symbols and terms are included in the glossary hereunder.
1. Name records and their associated name variants are conformed to a standardized format for loading into the database. Records are filtered for specific identifiable region, language and/or culture traits such as special characters and other unique elements (FIG. 8, Detail A). This process also detects and flags invalid ASCII characters (noise) and typographical errors. The records are further standardized by removing blank space and punctuation (KOLAPS) (FIG. 8, Detail C) and then compared to Known Name Patterns (graphemes, phonemes, morphemes, diacritical marks and special characters) to determine potential erroneous merging of an initial, honorific, military rank, professional degree or other formal title or surname affix (von, el, de, and so on) with name form in front or back position of name and/or to assign Personae™ language, culture and internal control codes (FIG. 8, Details F through H).
2. All remaining records which do not pass the filter process are sent to an exclusion table for further offline study and comparison before resubmission (FIG. 8, Detail J).
3. Once standardized, each new language is moved to its own stand-alone database with separate data tables for Authority and Non-Authority records where they cue with other name records for expanded processing in Level 2 and can be processed simultaneously along with any other language name forms from this point on.
4. At this time the results of Level 1 Processing has assigned the eight (8) digit CODEa as shown in FIG. 9 to each record which facilitates stratifying them into the customized sectors and categories (WEBvar, SYMvar etc.) as depicted in FIGS. 10 and 11.

As shown in FIG. 9, a code 116 (e.g., 16 digits) may be the combination of two separate code numbers: CODEa (8 digits) 116A and CODEb (8 digits) 116B. The data contained in CODEa 116A when coupled with a name in the Personae™ database results in a unique record. The breakdown of CODEa 116A is Gender, Language Code, Country Code, and a 2-digit Geographic Region code.

CODEb 116B may be partially reserved for government and future internal use, but may also include code positions for Origin, Culture, Equivalents, Transcultural and World Wide tags (as shown in FIGS. 10 and 11) and Gender Neutral code of a record's name or variants. The full list of codes are:

Sector 1—Lingual Codes (Language/Culture)
1. Transcultural Name Forms (FIG. 10, Detail A)
   Example: David, Mary, John etc.
   Definition: Name Forms found in multiple language/culture groups without alteration of their Romanized orthographic form.
2. World Wide Name Forms (FIG. 10, Detail B)
   Example: Sean, Ahmed, Fatima
   Definition: Name Forms and their Variants found in single language/culture groups which span multiple country/geographic regions without alteration of their Romanized orthographic form.
3. Related Name Forms (FIG. 10, Detail C)
   Equivalent name forms and/or their Variants which are shared across two or more language/cultures or country/regions but differentiated in their respective orthographic forms. Additional forms: SYMvar variants derived from foreign name assimilations, REGvar name forms comprised of logical equivalents or variant name forms from two or more language/culture groups with a shared linguistic and/or cultural heritage, UNIvar name forms and/or their variants which are uniquely listed within a single Language/Culture or Country/Region, which is contained in a larger World WideRegion/Sector and SURvar highest probability names for matched or unmatched personal and family names.
4. Extensible Mapping (FIG. 10, Detail D)
   Records map to several national and international standards including U.S. FIPS codes, ISO codes, and IANA codes allowing for multi-standard integration as well as referencing custom data sets such as language specific declensions and special characters cued by Top Level Domains (Tlds). Mapping increases relevance, prioritizing search results using native speaker distribution and population by region along with other customizable search and display functions such as “glocalization” (targeted e-commerce marketing using Tld mapping used in conjunction with user name and associated relevancies).

Sector 2—Geos Codes (Country/Region)
1. Geographic Regions (FIG. 11, Detail A)
   Regions comprised of Countries and/or Continents conforming to standard ISO Country codes and United Nations International Region codes.
2. World Wide Region (FIG. 11, Detail B)
   Example: English, Spanish, Muslim Name Forms
   A region comprised of language/culture groups with Name Forms/Variants spanning multiple country/regions without alteration of their Romanized orthographic form.
3. Subregions (FIG. 11, Detail C)
   Continents and Countries with regionally unique Name Forms/Variants for WW name forms in Item 2 above.
Extensible Mapping (FIG. 11, Detail D)
   Records map to several national and international standards including U.S. FIPS codes, ISO codes, and IANA codes allowing for multi-standard integration as well as referencing custom data sets such as language specific declensions and special characters cued by Top Level Domains (Tlds). Mapping increases relevance, prioritizing search results using native speaker distribution and population by region along with other customizable search and display functions.

Processing Level 2. The following may be implemented according to a processing level 2 methodology.
1. The records in the temporary table are then compared against a Universal Personal Name list of worldwide known names (used to track statistics but containing no name variants) and against the Master table of known and previously categorized unique names and variants to check for existing records. If the name does not exist it is added to the Master table along with its associated variants and that name becomes a primary unique record to be part of the finished product export and for future name comparisons in Master.
2. If the unique name/code combination does exist the variants are compared for both records and any new variants extracted and joined with the primary record in the Master table, expanding this unique record while keeping track of the original record the variant(s) were introduced from, thus enabling an audit trail of the changes made. This particular operation is called “Trickle-Up” processing and enables both the merging and purging of incoming records while simultaneously tracking and deleting duplicate records.

Processing Level 3. The following may be implemented according to a processing level 3 methodology.
1. Once “Trickle-Up” processing is completed the unique records contained in the Master table can be rearranged during the export process to accommodate the technical needs and customized application of each client on a per need basis. If the client requires a simplistic model the data can be exported using only name and CODEa as the unique identifier. For more robust applications (such as use in an investigative or law enforcement setting) data can be exported with both the name and CODEa+CODEb included.
2. The client can choose to receive the export data in either a simple Flat File or Relational database format, which can then be further indexed or manipulated to their own needs and specifications. Whichever the format, each client should have the basic tools and operators available in whatever choice of database software they use to display the following search results and name relationships.

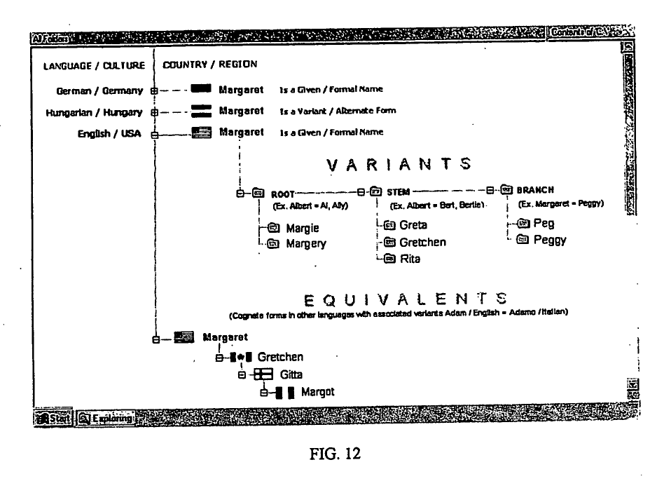

Sample Search Screen. A sample search screen is illustrated in FIG. 12. In this example, searches are initiated using a subject's personal and/or family name. The illustration is for demonstration only and is not an actual search result. Display order of search results is user selectable using relevance parameters such as popularity within a region, language and/or culture.

Client search is definable by the following parameters:
LEVEL 1—Root=variants derived from the headword's base morpheme (Albert=Al, Ally)
LEVEL 2—Stem=variants derived from secondary or compound morphemes within the root word (Albert=Bert, Bertie)
LEVEL 3—Branch=variants which are created through colloquial derivation or inflection (Margaret=Peggy, Maggie)
LEVEL 4—Equivalents=Cognate name forms found in other languages with any associated variants (Adam/English=Adamo/Italian)
LEVEL 5—Extended Search Parameters
WEBvar: names and/or variants including names derived from Artificial Languages (Elvish, Klingon), popular games (characters from Myst) and/or widely used online “name generators” are used in conjunction with Tld mapping to target e-commerce marketing (“glocalization”). Also used to flag most likely fraudulent name forms (e.g., some Klingon name forms resemble Arabic orthographically).
SYMvar: variants derived through assimilation of foreign names into their adopted “non-native” cultures [e.g., Amalnathan (Tamil) is likely to become Nathan and/or Nat or Nate in the United States].
TYPvar: variants based on most likely data entry errors (e.g. Marjane=engUS, female with “y” omitted; and Marjane=farIR, female).
PHOvar: variants based on “like sounding” name elements (phonemes) which render a type of “robotic pronunciation key.” Also used in SYMvar processing of incoming loan names based on equivalent “sounds”.
ORTvar: variants derived from parsing of names into additional name forms contained within them (e.g. William parsed=Liam).
LEXvar: equivalent name form searching between regions using “lexical” elements (morphemes) that render a type of “robotic meaning.”
REGvar: variants or equivalents derived from regions with a common linguistic and/or cultural heritage (Portugal/Brazil, Sweden/Finland/Norway) and disassociated nicknames (names not derived from another name e.g. Chip, Buddy and Bubba) which are regionally based.
TOPvar: variants or surnames which are geographically derived (toponymns) and code mapped to ISO, NGA, TIGRline and other standards are used for visiometric (visual data display) applications as well as logical linking to local resources.
COLvar: a search function for colloquially derived variants within a region, language and/or culture using dominant graphemes, phonemes and/or morphemes.
INIvar: a search function using most logical name(s) beginning with an initial determined and parsed in Level 1 processing and displayed based on popularity ranking within a region (e.g. VVeronika=Veronika/VeronikaV=Veronika plus initial V=Victoria)
UNIvar: a search function for unique name forms and/or variants which are within a single region, language and/or culture contained in a larger World Wide Region (e.g., Sharon=engWW, Shazzo (variant)=engAU).
SURvar: a search function using 100% matching between region, language and/or culture of two or more names (e.g. Juan—personal name and Valdez—surname both=Spanish) to narrow the searched records to matched region, language and/or culture. A mixed result (Spanish/Hebrew) searches both regions, languages and/or cultures with priority given to the names from the regions, languages and/or cultures with the larger number of native speakers. Additionally, SURvar provides a “predictive” variant search function utilizing names and/or variants for personal names also contained within surnames.

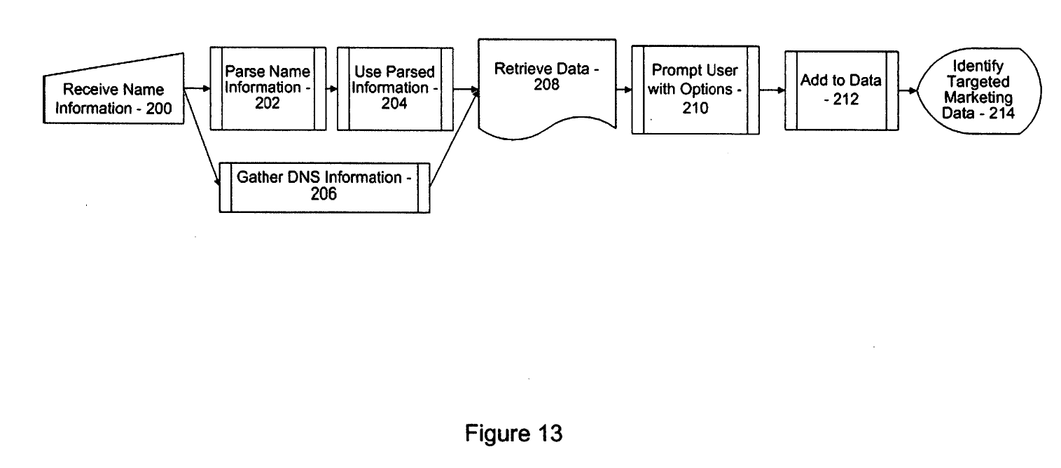

Referring to FIG. 13, shown is one implementation of the present invention. In this implementation, (in step 200) an online client/user/shopper interfaces with a website which incorporates the present invention. At any point in this interface (logon, search, order placement, point of purchase (checkout) or logoff) the online client/user/shopper is prompted to enter name information (personal name, user name/user ID, email address and/or credit card information).

The system then (in 202) parses the name information from supplied data. For instance, using parsing function (e.g. for name=searches from left position one character, two characters, three characters etc. until match; or for email, username/user ID=deletes @ symbol or other delimiter and starts left in remaining data one character, two character to match database table data (personal names, language, lexical, region, WEBvar, CENSUS data etc.)) to create first confidence level in one or more languages/cultures and/or regions.

The system then (in step 204) uses name information to locate language, culture, country and/or region information. For instance, it could record a map to several national and international standards including, but not limited to, U.S. FIPS codes, ISO codes, and IANA codes allowing for multi-standard integration as well as referencing custom data sets such as language specific declensions and special characters cued by Top Level Domains (Tlds). Mapping increases relevance, prioritizing search results using native speaker distribution and population by region along with other customizable search and display functions such as “glocalization” (targeted e-commerce marketing using Tld mapping used in conjunction with user name and associated relevancies).

Preferably, meanwhile, in step 206, the system received DNS information to determine the name information's current geographical location. For instance, a user's IP address could be compared against the databases received from Internet registries organizations such as ARIN, APNIC, RIPE. This will return information such as country, region, and city codes. Depending on the database used, additional information such as latitude, longitude, time zone, and local currency may also be available.

In step 208, the system returns language, culture, country and/or region information and calculates marketing data confidence level inclusive of reverse DNS geographical location. The user could then be, in step 210, prompted to continue using specific language(s) and/or Nicknames. Then, in step 212, the chosen language and nicknames would be added to the perpetual/ongoing statistics. The gathering of these specific counts based on the region/language and nickname will further refine the database with each new entry. Finally, the information (step 214) is used to identify targeted marketing data for both on-line and off-line applications.

In first example of a use of such a system, Miguel Fuentes enters his name information to begin applying for an online course. A search of his name information with added reverse DNS confidence returns three languages and three variants of his name used in Spain. The name variants are held in a buffer as Miguel is prompted to continue the transaction in one of the three languages. Having made the choice of Catalan, Miguel is furthered prompted as to whether or not he would like to be called one of the Catalan nicknames or a different nickname of his choice. He chooses the latter and enters his chosen nickname. The name variants are held in a buffer as Miguel is prompted to continue the transaction in one of the three languages.

In a second example, the same scenario as the first example applies, but the system adds count 1 to Tally column for catES, male=Miguel.

In a third example, Miguel Fuentes is applying for an online course. In addition to the usual banner ads regarding other online schools and courses, Miguel is also shown an ad for an upcoming boat race near his home in Seville based on revealed facts about his: preferred language, likely age and gender (era name popularity stats plus what marketers know about online age demos), nearest town (Tld/DNS) and other related demographics derived from this information. As the database builds, additional primary preferences for Spaniards may emerge.

In a fourth example, Miguel enters “mr2@yahoo.com” as his user ID, the system parses Toyota model MR2 which triggers Toyota marketing based on known color preferences of Catalan speaking Spaniards that reside in his geographic area. Again, all confidence is derived from either name information or “lexical” (LEXvar/WEBvar) intelligence of parsed personal name, email, user name/user ID or credit card data and related statistics.”

In an example of offline use, by utilizing server logs from the clients web servers, the logged IP address information can be compared against the users named account information and then return specific marketing data for offline print marketing or other bulk mailing programs. Pulling this data from historical data will increase the “value” and give a better ROI as the system can be used for “live” transactions, as well as historical data.

Glossary of Terminology. Provided below is a glossary of terms and symbols used in this description:
Variant: alternate name forms derived primarily through changes which are orthographic (spelling/graphemes) and/or phonological (sound/phonemes). Variants take on these primary forms: root, stem, and branch.
Colloquial: a variant which is a nickname or pet name. (e.g. Margaret=Peggy)
Equivalent: Names from different regions, languages and/or cultures which are understood to share the same meaning John (English)=Johannes (German)=Juan (Spanish)=Jean (French).
WEBvar: names and/or variants including names derived from Artificial Languages (Elvish, Klingon), popular games (characters from Myst) and/or widely used online “name generators” are used in conjunction with Tld mapping to target e-commerce marketing (“glocalization”) and to flag most likely fraudulent name forms (e.g., some Klingon name forms resemble Arabic names orthographically).
SYMvar: refers to an alternate variant type as identified by the methodology of the invention. SYMvar variants are derived by the natural assimilation of foreign names into their adopted “non-native” cultures. (e.g. Amalnathan (Tamil) is likely to become Nathan and/or Nat or Nate in the United States).
REGvar: refers to an alternate variant type identified by the methodology of the invention. REGvar equivalents and/or variants are derived from regions with a common linguistic and/or cultural heritage (Portugal/Brazil, Sweden/Finland/Norway) and disassociated nicknames (names not derived from another name e.g. Chip, Buddy and Bubba) which are regionally based.
Anagrams: refers to a word or phrase formed by reordering the letters of another word or phrase, such as satin to stain.
Forbidden name: name forms which are prohibited through religious proscription or other cultural norms.
Honorifics: refers to a title, phrase, or grammatical form conveying respect, used especially when addressing a social superior that may be mistakenly entered as names.
Highest probability names for initials: refers to name forms which are suggested to the user based on the highest instance names occurring within that language/culture and/or country/region.
Graphemes: representative letter groups, diacritical marks and other orthographic standards used within regions, languages and/or cultures.
Phonemes: “sound” of graphemes as spoken within regions, languages and/or cultures.
Morphemes: the smallest unit of “meaning” within regions, languages and/or cultures as represented by graphemes and/or phonemes.
Full Text Searching: refers to “one to one” exact name matching without using algorithms.
Personal Names: commonly known in western societies as first name, given name, Christian name. May also include Family Name.
Family Name: commonly known in western societies as surnames, last name, in other regions may include tribal name, father's name (patronym), mother's name (matronym) occupations or names indicating religious affiliation.
Authority files: official, predictable and recurring file types which include governmental data, census tables, scholarly works, phone book listings etc that contain or allow for statistical weighting and/or linguistic research and verification.
Non-Authority files: unofficial, random and/or non-standardized files that include newspaper stories, baby books, genealogy files, etc., which are all popular sources for naming. So popular that the inventors follow the cultural rule that “if it's in print, it exists.”
SURvar: search function using 100% matching between region, language and/or culture of two or more names (e.g. Juan—personal name and Valdez—surname both=Spanish) to narrow the searched records to matched region, language and/or culture. A mixed result (Spanish/Hebrew) searches both regions, languages and/or cultures with priority given to the names from the regions, languages and/or cultures with the larger number of native speakers. Additionally, SURvar provides a “predictive” variant search function utilizing names and/or variants for personal names also contained within surnames.
UNIvar: unique name forms and/or their variants which are uniquely listed within a single Language/Culture or Country/Region, which is contained in a larger World Wide Region (e.g., Sharon=engWW, Shazzo (var.)=engAU).
TYPvar: models statistical occurrence or likelihood of transliterative and/or typing “variance” within and/or outside regions, languages and/or cultures. For example: Marjane=engUS, female with “y” omitted; and Marjane=farIR, female.
TYPvar Concept: when present in a randomized data set, it is not known if these are data entry errors or actual name forms. The logical search vectors, then, are those which examine every logical and statistically supportable “answer.” These results can be weighted—1) add “matching” LAN/CO surname (Satrapi) and the second option moves to the first position etc. But this is NOT an absolute: the intersection of global cultures still imposes the reality that Marjane may in fact be a typographically incorrect entry for an Iranian female named Maryjane.
TOPvar: variants or surnames which are geographically derived (toponyms) and code mapped to ISO, NGA, TIGRline and other standards are used for visiometric (visual data display) applications as well as logical linking to local resources. For example, in a law enforcement application, toponymns and/or regionalized tribal names from Waziristan could be assigned precedence over names from Kuwait and used to “call” maps and additional resources for the region of interest.
LEXvar: tool created from analysis of dominant corpus “lexical” elements (morphemes) that renders a type of “robotic meaning” which is used for equivalency analysis functions between LAN/COs. Also used to filter name data and expunge “non-name forms” and to determine dominant graphemes, phonemes and morphemes within a region for “predictive” filtering of incoming name data (e.g. von=surname prefix deuDE).
PHOvar: analysis of dominant corpus “lexical” elements (phonemes) renders a type of “robotic pronunciation key” which is used for ranking “like sounding” parsed name elements based on occurrence. Can also be used to determine SYMvar of incoming loan names based on equivalent “sounds”.
ORTvar: parsing of name forms to find additional name forms within and/or outside LAN/CO (William=Liam).
COLvar: a “predictive” function for determining colloquially derived name forms based on dominant graphemes, phonemes and morphemes within regions, languages and/or cultures.
Logon: the point at which the user enters a unique identifier such as a user name or email address that represents their own personal identification on the specific web site.
Search: the point at which the user enters a search criteria on a web site. The information entered into the search will be used to cross reference with the language, culture, country and/or region information to better market specific products or services to the user.
Order Placement: the point at which the user enters specific products to purchase on a web site. The information entered into the order will be used to cross reference with the language, culture, country and/or region information to better market specific products or services to the user.
Point of Purchase or Checkout: the point at which the user has entered all products to purchase and has made a final decision on making their purchase and will be either making payment for the products or choosing to cancel out of the transaction. At this point all information entered into the order will be used to cross reference with the language, culture, country and/or region information to better target additional market specific products or services to the user. If the user chooses to cancel out of the transaction, the algorithmically triggered language, culture, region information and/or the associated marketing information can still be utilized for future study.
Logoff: the point at which the user disconnects from the web site and is now browsing in an anonymous mode. At the point at which the user logs off, the user can be prompted with final marketing data using the language, culture, country and/or region information.
User Name/User ID: A unique personal identification that is only used by a specific person. In most cases, the unique identifier on a specific site or system is the user ID but could also be the email address or the person's actual name (personal name).
Email Address: The email address can be parsed out into multiple user identifiable fields. The first being the TLD which is the two or three letters following the dot “.” such as .com, .gov, .eu, etc. The second being the domain name which are all characters following the “@” sign such as microsoft.com, intercom or earthlink.net. This information is useful in determining the location and the location may possibly point to specific interests of the user as well (e.g. gardening.com=botanical interests, music.com=musician or music fan). The third unique identifier is comprised of all the characters before the “@” character. Typically this would be the user's first initial and last name (Family Name), or just first name, or first name plus last name or any combination of the above with numbers as a prefix or suffix. It could also be a movie or game character, celebrities, favorite car, or any other cultural icons found within the database search tables or lexical lists. All of this information will then be parsed further and/or referenced in the database to return language, region, marketing data and/or additional nicknames or transaction language choices that further qualifies the user's cultural information or interests for targeted marketing purposes.
Credit Card Information. Credit card information is the unique account information that the user enters into the web site to make payments for products or services. The account number can then be cross referenced to the type of credit card such as a Disney Visa or AAA Visa or Robinsons May Master Card for any special offers or discounts pertinent to those types of cards in order of precedence as determined by the language, culture, country and/or region information (callouts 3 thru 8) and subsequent targeted marketing data.
DNS Information: the Internet's domain-name system (DNS) allows users to refer to web sites and other resources using easier-to-remember domain names (such as “www.icann.org”) rather than the all-numeric IP addresses (such as “192.0.34.65”) assigned to each computer on the Internet. Each domain name is made up of a series of character strings (called “labels”) separated by dots. The right-most label in a domain name is referred to as its “top-level domain” (TLD). There are several types of TLDs within the DNS: TLDs with two letters (such as .de, .mx, and .jp) have been established for over 240 countries and external territories and are referred to as “country-code” TLDs or “ccTLDs.” They are delegated to designated managers, who operate the ccTLDs according to local policies that are adapted to best meet the economic, cultural, linguistic, and legal circumstances of the country or territory involved. Most TLDs with three or more characters are referred to as “generic” TLDs, or “gTLDs.”

Those skilled in the art will understand that the preceding embodiments of the present invention provide the foundation for numerous alternatives and modifications thereto. These other modifications are also within the scope of the present invention. Accordingly, the present invention is not limited to that precisely as shown and described in the present invention.

What is claimed is:

1. A method for generating a name database including a plurality of records, each of the records being associated with a name and each including a plurality of fields, at least one of the fields of the records being associated with a variant of the name, the name having a plurality of characteristics, at least one origin, and potentially a plurality of variants, the method comprising:
a. implementing a plurality of rules for analyzing the characteristics of the name, the plurality of rules including rules associated with determining a variant of a name based upon the characteristics of the name, a number of the rules being based upon at least one of the following:
i. geographical parameters; and
ii. cultural parameters; and
b. applying at least one of the rules to a name to determine an origin of the name.

2. The method of claim 1 wherein the applying step comprises applying at least one of the rules to a name to determine a language of the origin of the name.

3. The method of claim 1 wherein the applying step comprises applying at least one of the rules to a name to determine a country of the origin of the name.

4. The method of claim 1 wherein the name includes a given name.

5. The method of claim 1 wherein the name includes a surname.

6. The method of claim 1 further comprising applying at least one of the rules to a name to determine whether the name has a variant.

7. The method of claim 1 wherein the geographic parameters and the cultural parameters each include linguistic parameters.

8. The method of claim 1 further comprising applying the plurality of rules to a name to determine at least one variant of the name.

9. A method for conducting e-commerce with a user on a computer with a top-level domain (Tld), the method comprising:
a. receiving a name of the user;
b. determining an origin of the name;
C. applying at least one rule to the name based on the origin to determine whether the name has a variant; and
d. if the name has a variant, providing the variant to the user.

10. The method of claim 9, wherein the determining step comprises accessing a name database including a plurality of records each associated with a name;
a. each of the names having a plurality of characteristics, at least one origin, and potentially a plurality of variants;
b. each of the records including a plurality of fields including fields associated with variants of the name and fields associated with at least one code that identifies characteristics of the name.

11. The method of claim 10, wherein each of the records includes a field associated with a top-level domain.

12. A method of identifying targeted marketing information relevant to a user, said method comprising the steps of:
acquiring personal information from said user;
analyzing said personal information to determine the user's name;
determining the name origin of said user's name;
using said name origin to select data from a database relevant to said user; and
using said data to identify targeted marketing information relevant to said user.

13. The method of claim 12, wherein said personal information comprises name information, cultural affiliation and interests.

14. The method of claim 12, further comprising the steps of:
acquiring the user's Internet protocol address;
determining the user's geographical location from said Internet protocol address; and
using said geographical location along with said name origin to select data from a database relevant to said user.

15. The method of claim 12, further comprising the steps of:
using said data to determine additional questions to said user;
soliciting said user's response to said additional questions;
collecting the user's response; and
adding user's response to said data.

16. The method of claim 12, wherein said personal information comprises name information, cultural affiliation and interests; and wherein said method comprises the steps of:
acquiring the user's Internet protocol address;
determining the user's geographical location from said Internet protocol address; and
using said geographical location along with said name origin to select data from a database relevant to said user.

17. The method of claim 16, further comprising the steps of:
using said data to determine additional questions to said user;
soliciting said user's response to said additional questions;
collecting the user's response; and
adding user's response to said data.

18. The method of claim 12, further comprising the steps of:
acquiring the user's Internet protocol address;
determining the user's geographical location from said Internet protocol address;
using said geographical location along with said name origin to select data from a database relevant to said user;
using said data to determine additional questions to said user;
soliciting said user's response to said additional questions;
collecting the user's response; and
adding user's response to said data.

19. The method of claim 18, wherein said personal information comprises name information, cultural affiliation and interests.

20. The method of claim 12, wherein said personal information comprises name information, cultural affiliation and interests, said method further comprising the steps of:
using said data to determine additional questions to said user;
soliciting said user's response to said additional questions;
collecting the user's response; and
adding user's response to said data.
